(19) United States
(12) Patent Application Publication
(10) Pub. No.: US 2012/0119824 A1
(43) Pub. Date: May 17, 2012

(54) BIAS VOLTAGE SOURCE

(75) Inventors: Anand Seshadri, Richardson, TX (US); Weize Xiong, Plano, TX (US)

(73) Assignee: TEXAS INSTRUMENTS INCORPORATED, Dallas, TX (US)

(21) Appl. No.: 13/196,058

(22) Filed: Aug. 2, 2011

Related U.S. Application Data
(60) Provisional application No. 61/414,181, filed on Nov. 16, 2010.

(51) Int. Cl. G05F 3/24

(52) U.S. Cl. 327/537

(57) ABSTRACT

An integrated circuit that includes a data storage cell. The data storage cell has a PMOS transistor in an n-well. In addition, the data storage cell has a PMOS diode connecting a voltage source to a bias node of the n-well. Alternatively, an integrated circuit that includes a data storage cell. The alternative data storage cell has an NMOS transistor in an isolated p-well. In addition, the alternative data storage cell has an NMOS diode connecting a voltage source to a bias node of the isolated p-well.

### CROSS-REFERENCE TO RELATED APPLICATIONS

This application claims the benefit of priority under U.S.C. §119(e) of U.S. Provisional Application 61/414,181 (Texas Instruments docket number TI-66579PS, filed Nov. 16, 2010, and titled “Adaptive Nwell Biasing Scheme To Reduce SRAM Retention Power”).

Moreover, this application is related to patent application Ser. No. 13/______ (Attorney Docket Number TI-66544, filed simultaneously with this application) entitled “SRAM Cell Having An N-Well Bias”, and patent application Ser. No. 13/______ (Attorney Docket Number TI-66555, also filed simultaneously with this application) entitled “SRAM Cell Having a P-Well Bias”. With their mention in this section, these patent applications are not admitted to be prior art with respect to the present application.

### BACKGROUND

Embodiments relate to the field of integrated circuits. More particularly, embodiments relate to data storage circuits.

### DESCRIPTION OF THE VIEWS OF THE DRAWING

FIG. 1A is a circuit diagram of an integrated circuit containing an SRAM with a self-regulating n-well bias voltage source using a PMOS diode according to a first embodiment.

FIG. 1B is a circuit diagram of an integrated circuit containing a DRAM with a self-regulating n-well bias voltage source using a PMOS diode according to the first embodiment.

FIG. 2 is a circuit diagram of an integrated circuit containing a data storage circuit with a self-regulating n-well bias voltage source using a PMOS diode according to a second embodiment.

FIG. 3 is a circuit diagram of an integrated circuit containing a data storage circuit with a self-regulating n-well bias voltage source using a PMOS diode according to a third embodiment.

FIG. 4A is a circuit diagram of an integrated circuit containing a data storage circuit such as an SRAM or a data latch with a self-regulating isolated p-well bias voltage source using an NMOS diode according to a fourth embodiment.

FIG. 4B is a circuit diagram of an integrated circuit containing a DRAM with a self-regulating isolated p-well bias voltage source using an NMOS diode according to the fourth embodiment.

FIG. 5 is a circuit diagram of an integrated circuit containing a data storage circuit with a self-regulating isolated p-well bias voltage source using an NMOS diode according to a fifth embodiment.

FIG. 6 is a circuit diagram of an integrated circuit containing a data storage circuit with a self-regulating isolated p-well bias voltage source using an NMOS diode according to a sixth embodiment.

FIG. 7A through FIG. 7F are circuit diagrams of embodiments of switches which may be used to couple gate nodes of PMOS diodes or NMOS diodes to n-well bias nodes or isolated p-well bias nodes, respectively.

### DETAILED DESCRIPTION

The example embodiments are described with reference to the attached figures, wherein like reference numerals are used throughout the figures to designate similar or equivalent elements. The figures are not drawn to scale and they are provided merely to illustrate the example embodiments. Several aspects are described below with reference to example applications for illustration. It should be understood that numerous specific details, relationships, and methods are set forth to provide a full understanding of the example embodiments. One skilled in the relevant art, however, will readily recognize that the example embodiments can be practiced without one or more of the specific details or with other methods. In other instances, well-known structures or operations are not shown in detail to avoid obscuring the embodiment. The example embodiments are not limited by the illustrated ordering of acts or events, as some acts may occur in different orders and/or concurrently with other acts or events. Furthermore, not all illustrated acts or events are required to implement a methodology in accordance with the example embodiments.

An integrated circuit containing a data storage circuit (such as a static random access memory (“SRAM”), dynamic random access memory (“DRAM”) or logic latch) may provide voltage sources for biasing n-type wells (“n-wells”) within the data storage circuit during various modes of operation. In one or more modes of operation (for example a reduced power data retention mode) an n-well bias level that provides a desired level of power consumption of the PMOS transistors may not be available from any of the voltage sources in the integrated circuit. Therefore, a self-regulating n-well bias voltage source may be created by coupling two voltage sources. In such a configuration, the bias voltage to the n-wells may be regulated to control the power consumption of the PMOS transistors in the data storage cells.

Alternatively, an integrated circuit may contain a data storage circuit with re-channel metal oxide semiconductor (“NMOS”) transistors in electrically isolated p-type wells (“isolated p-wells”). The integrated circuit may provide voltage sources for biasing the isolated p-wells during various modes of operation. However, in one or more modes of operation (for example a reduced power data retention mode) a desired isolated p-well bias level may not be provided by any of the voltages sources available in the integrated circuit. Therefore, a self-regulating isolated p-well bias voltage source may be formed by coupling two voltage sources. In such a configuration, the bias voltage to the isolated p-wells may be regulated to control the power consumption of the NMOS transistors in the data storage cells.

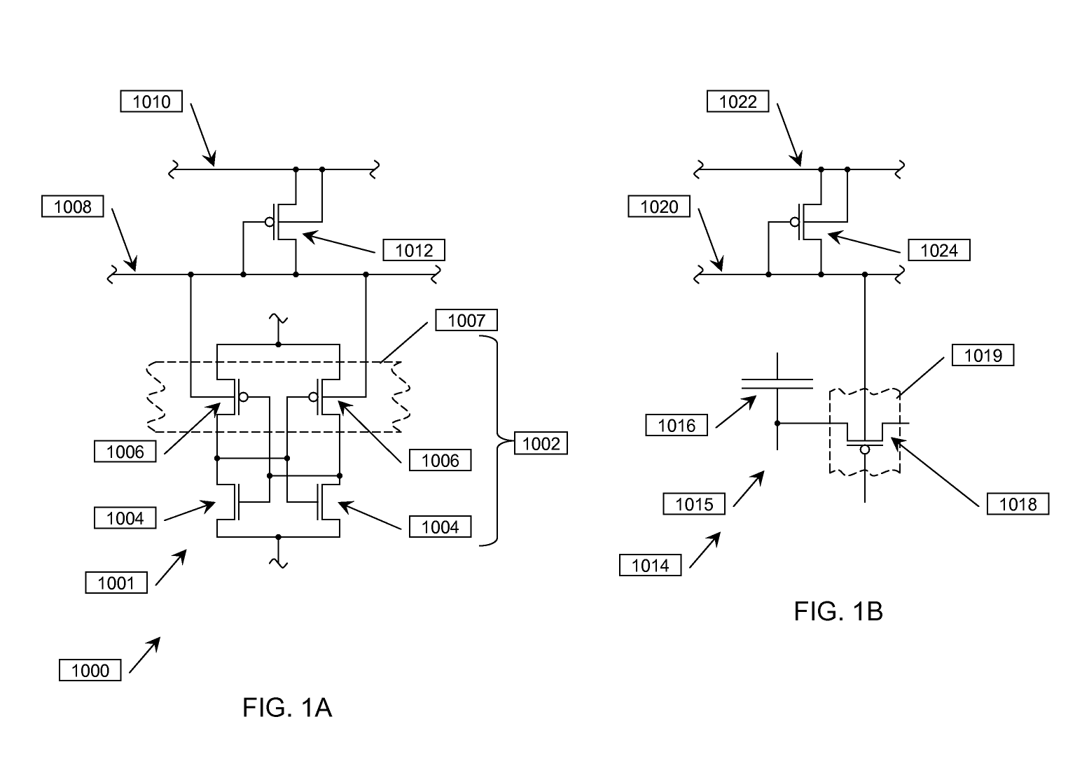

FIG. 1A is a circuit diagram of an integrated circuit containing an SRAM with a self-regulating n-well bias voltage source using a PMOS diode formed according to a first embodiment. More specifically, the integrated circuit (1000) contains a memory component such as an SRAM comprised of SRAM data storage cells (1001). In each SRAM cell (1001), a pair of cross-coupled inverters (1002) has both NMOS transistors (1004) and PMOS transistors (1006). One or more n-wells (1007) surround the PMOS transistors (1006) of each SRAM data storage cell (1001) (and possibly other PMOS transistors contained within the SRAM cell, such as passgate transistors or read buffer transistors). The one or more n-wells (1007) are connected to an n-well bias node (1008), as depicted in FIG. 1A.

The integrated circuit voltage source (1010) has a higher voltage level than the voltage level that would provide a desired level of power consumption in the PMOS transistors (1006). Therefore, a self-regulating n-well bias voltage source is formed by coupling the integrated circuit voltage source (1010) to a PMOS diode (1012) that is coupled to the n-well bias node (1008). More specifically, the source node of the PMOS diode (1012) is connected to the integrated circuit voltage source (1010), the drain node of the PMOS diode (1012) is connected to the n-well bias node (1008), and the gate node of the PMOS diode (1012) is connected to the n-well bias node (1008). In addition, the substrate node of the PMOS diode (1012) may be connected to the integrated circuit voltage source (1010) or other suitable bias supply. During the operation of the SRAM, the PMOS diode (1012) may regulate a bias voltage on the n-well bias node (1008) as a function of the current flowing through the PMOS diode (1012).

FIG. 1B is a circuit diagram of an integrated circuit containing a DRAM with a self-regulating n-well bias voltage source using a PMOS diode formed according to the first embodiment. More specifically, the integrated circuit (1014) contains a DRAM comprised of DRAM data storage cells (1015). Each DRAM cell (1015) includes a data storage capacitor (1016) and a PMOS passgate transistor (1018). One or more n-wells (1019) underlie each DRAM cell (1015) and surround the PMOS transistor (1018). The one or more n-wells (1019) are connected to an n-well bias node (1020), as depicted in FIG. 1B.

The integrated circuit voltage source (1022) has a higher voltage level than the voltage level that would provide a desired level of power consumption in the PMOS transistor (1018). Therefore, a self-regulating n-well bias voltage source is formed by coupling the integrated circuit voltage source (1022) to a PMOS diode (1024) that is coupled to the n-well bias node (1020). More specifically, the source node of the PMOS diode (1024) is connected to the integrated circuit voltage source (1022), the drain node of the PMOS diode (1024) is connected to the n-well bias node (1020), and the gate node of the PMOS diode (1024) is connected to the n-well bias node (1020). In addition, a substrate node of the PMOS diode (1024) may be connected to the voltage source (1022) or other suitable bias supply. During the operation of the DRAM, the PMOS diode (1024) may regulate a bias voltage on the n-well bias node (1020) as a function of the current flowing through the PMOS diode (1024).

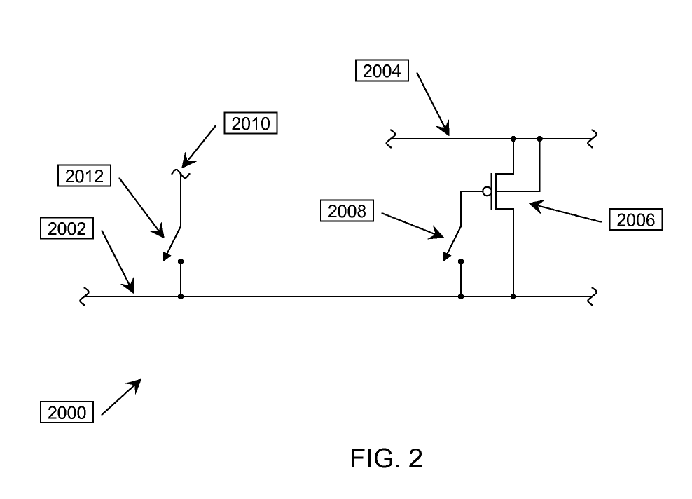

FIG. 2 is a circuit diagram of an integrated circuit containing a self-regulating n-well bias voltage source using a PMOS diode formed according to a second embodiment. The integrated circuit (2000) contains a data storage circuit (such as an SRAM, a DRAM or a logic latch) having data storage cells. Each data storage cell includes PMOS transistors (such as element 1006 of FIG. 1A). One or more n-wells that underlie each data storage cell (and contain those PMOS transistors) are connected to an n-well bias node (2002) (that may be an n-well bias bus), as depicted in FIG. 2. The integrated circuit voltage source (2004) has a higher voltage level than desired for the targeted amount of power consumption by the PMOS transistors. The integrated circuit voltage source (2004) may also have a higher voltage level than desired for another parameter such as data reliability during read/write operations. Therefore, a self-regulating n-well bias voltage source is created by coupling an integrated circuit voltage source (2004) to a PMOS diode (2006) that is coupled to the n-well bias node (2002). (The PMOS diode (2006) could be PMOS diode (1012) of FIG. 1A.) The voltage source (2004) has a higher voltage level than a voltage level which provides a desired level of power consumption, or possibly a desired level of another parameter such as data reliability during read/write operations, in the PMOS transistors. More specifically, a source node of the PMOS diode (2006) is connected to the integrated circuit voltage source (2004), a drain node of the PMOS diode (2006) is connected to the n-well bias node (2002), and a gate node of the PMOS diode (2006) is coupled to the n-well bias node (2002) through a first n-well mode switch (2008). An alternate n-well bias source (2010) is coupled to the n-well bias node (2002) through a second n-well mode switch (2012).

During operation of the SRAM (for example, a reduced power data retention mode) the first n-well mode switch (2008) may be closed and the second n-well mode switch (2012) may be opened. This may allow the PMOS diode (2006) to regulate a bias voltage on the n-well bias node (2002) as a function of current flowing through the PMOS diode (2006). In other modes of operation (for example reading and writing) the first n-well mode switch (2008) may be opened and the second n-well mode switch (2012) may be closed to provide a bias to the n-well bias node (2002) from the alternate n-well bias source (2010).

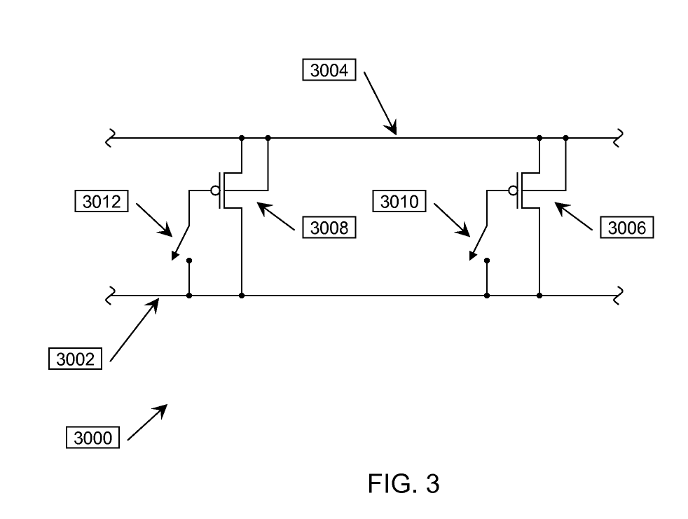

FIG. 3 is a circuit diagram of an integrated circuit containing a self-regulating n-well bias voltage source using a PMOS diode formed according to a third embodiment. The integrated circuit (3000) contains a data storage circuit (such as an SRAM, a DRAM or a logic latch) having data storage cells. Each data storage cell includes PMOS transistors (such as element 1006 of FIG. 1A). One or more n-wells that underlying each data storage cell (and contain those PMOS transistors) are connected to an n-well bias node (3002) (that may be an n-well bias bus), as depicted in FIG. 3. The integrated circuit voltage source (3004) has a higher voltage level than desired for the targeted amount of power consumption by the PMOS transistors. Therefore, a self-regulating n-well bias voltage source is created by coupling a voltage source (3004) to a first PMOS diode (3006) in parallel with a second PMOS diode (3008); both of which are coupled to the n-well bias node (3002). More specifically, a source node of the first PMOS diode (3006) is connected to the integrated circuit voltage source (3004), a drain node of the first PMOS diode (3006) is connected to the n-well bias node (3002), and a gate node of the first PMOS diode (3006) is coupled to the n-well bias node (3002) through a first n-well mode switch (3010). In addition, a source node of the second PMOS diode (3008) is connected to the integrated circuit voltage source (3004), a drain node of the second PMOS diode (3008) is connected to the n-well bias node (3002), and a gate node of the second PMOS diode (3008) is coupled to the n-well bias node (3002) through a second n-well mode switch (3012).

During operation of the data storage circuit in one mode of operation (for example, a first reduced power data retention mode) the first n-well mode switch (3010) may be closed and the second n-well mode switch (3012) may be opened. This may enable the first PMOS diode (3006) to regulate a bias voltage on the n-well bias node (3002) in a first desired voltage range as a function of the current flowing through the first PMOS diode (3006). During another mode of operation (for example, a second reduced power data retention mode) the first n-well mode switch (3010) may be opened and the second n-well mode switch (3012) may be closed. This may enable the second PMOS diode (3008) to regulate a bias voltage on the n-well bias node (3002) in a second desired voltage range as a function of the current flowing through the second PMOS diode (3008). During yet another mode of operation (for example, a third reduced power data retention mode) the first n-well mode switch (3010) and the second n-well mode switch (3012) may both be closed. This may enable the first PMOS diode (3006) and the second PMOS diode (3008) to regulate a bias voltage on the n-well bias node (3002) in a third desired voltage range as a function of current flowing through both the first PMOS diode (3006) and the second PMOS diode (3008).

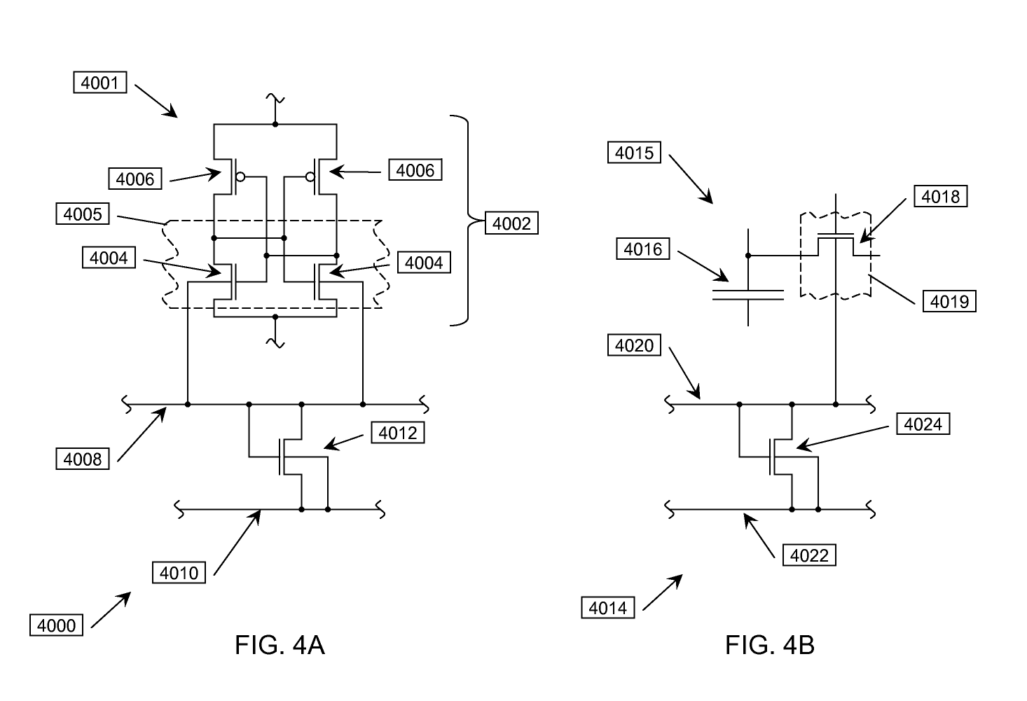

FIG. 4A is a circuit diagram of an integrated circuit formed according to a fourth embodiment. The integrated circuit (4000) contains a data storage cell (4001) (such as an SRAM or a data latch) with a self-regulating isolated p-well bias voltage source that uses an NMOS diode. In each data storage cell (4001) of the data storage circuit, a pair of cross-coupled inverters (4002) is formed of PMOS transistors (4006) and NMOS transistors (4004) in isolated p-wells (4005). One or more isolated p-wells (4005) underlie each data storage cell (4001) and surround the NMOS transistors (4004) (and possibly other NMOS transistors such as passgate transistors or read buffer transistors). The isolated p-wells (4005) are connected to an isolated p-well bias node (4008) (that may be an isolated p-well bias bus), as depicted in FIG. 4A. The integrated circuit voltage source (4010) has a lower voltage level than a desired for the targeted amount of power consumption by the NMOS transistors (4004). Therefore, a self-regulating isolated p-well bias voltage source is created by coupling the voltage source (4010) to an NMOS diode (4012) that is coupled to the isolated p-well bias node (4008). More specifically, a source node of the NMOS diode (4012) is connected to the voltage source (4010), a drain node of the NMOS diode (4012) is connected to the isolated p-well bias node (4008), and a gate node of the NMOS diode (4012) is connected to the isolated p-well bias node (4008). In addition, a substrate node of the NMOS diode (4012) may be connected to the voltage source (4010) or other suitable bias supply. During the operation of the data storage circuit, the NMOS diode (4012) may regulate a bias voltage on the isolated p-well bias node (4008) as a function of the current flowing through the NMOS diode (4012).

FIG. 4B is a circuit diagram of an integrated circuit containing a DRAM with a self-regulating isolated p-well bias voltage source using an NMOS diode formed according to the fourth embodiment. More specifically, the integrated circuit (4014) contains a memory component such as a DRAM having DRAM data storage cells (4015). Each DRAM data storage cell (4015) includes a data storage capacitor (4016) and an NMOS passgate transistor (4018). One or more isolated p-wells (4019) underlie each DRAM cell and contain the NMOS transistor (4018). The isolated p-wells (4019) are connected to an isolated p-well bias node (4020) (that may be an isolated p-well bias bus), as depicted in FIG. 4B. The integrated circuit voltage source (4022) has a lower voltage level than desired for the targeted level of power consumption by the NMOS transistor (4018) (or possibly a lower voltage level than desired for another parameter such as data stability during read/write operations). Therefore, a self-regulating isolated p-well bias voltage source is created by coupling the integrated circuit voltage source (4022) to an NMOS diode (4024) that is coupled to the isolated p-well bias node (4020). More specifically, a source node of the NMOS diode (4024) is connected to the voltage source (4022), a drain node of the NMOS diode (4024) is connected to the isolated p-well bias node (4020), and a gate node of the NMOS diode (4024) is connected to the isolated p-well bias node (4020). In addition, a substrate node of the NMOS diode (4024) may be connected to the voltage source (4022) or other suitable bias supply. During the operation of the DRAM, the NMOS diode (4024) may regulate a bias voltage on the isolated p-well bias node (4020) as a function of the current flowing through the NMOS diode (4024).

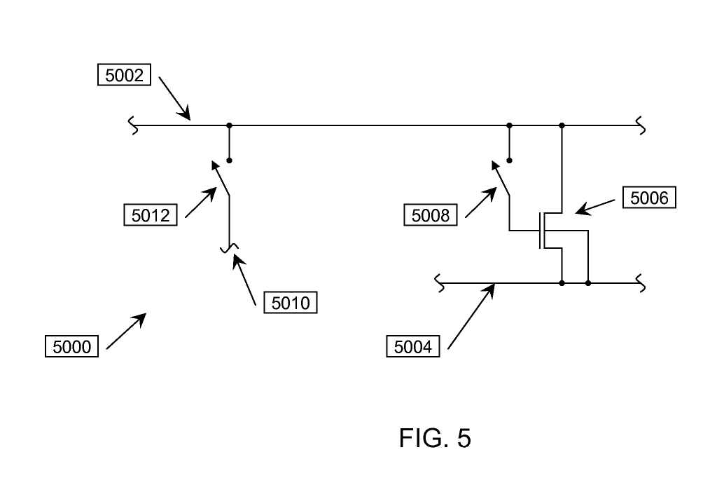

FIG. 5 is a circuit diagram of an integrated circuit containing a self-regulating isolated p-well bias voltage source using an NMOS diode formed according to a fifth embodiment. The integrated circuit (5000) contains a data storage circuit having data storage cells. Each data storage cell includes NMOS transistors (such as element 4004 in FIG. 4A). One or more isolated p-wells underlying each data storage cell and contain those NMOS transistors. The isolated p-wells are connected to an isolated p-well bias node (5002) (that may be an isolated p-well bias bus), as depicted in FIG. 5. The voltage source (5004) may have a lower voltage level than desired for the targeted amount of power consumption by the NMOS transistors. Therefore, a self-regulating isolated p-well bias voltage source is created by coupling an integrated circuit voltage source (5004) to an NMOS diode (5006) that is coupled to the isolated p-well bias node (5002). More specifically, a source node of the NMOS diode (5006) is connected to the integrated circuit voltage source (5004), a drain node of the NMOS diode (5006) is connected to the isolated p-well bias node (5002), and a gate node of the NMOS diode (5006) is coupled to the isolated p-well bias node (5002) through a first isolated p-well mode switch (5008). An alternate isolated p-well bias source (5010) is coupled to the isolated p-well bias node (5002) through a second isolated p-well mode switch (5012).

During the operation of the SRAM (for example, a reduced power data retention mode), the first isolated p-well mode switch (5008) may be closed and the second isolated p-well mode switch (5012) may be opened. This may enable the NMOS diode (5006) to regulate a bias voltage on the isolated p-well bias node (5002) as a function of the current flowing through the NMOS diode (5006). In other modes of operation (for example, reading and writing) the first isolated p-well mode switch (5008) may be opened and the second isolated p-well mode switch (5012) may be closed. This may provide a bias voltage to the isolated p-well bias node (5002) from the alternate isolated p-well bias source (5010).

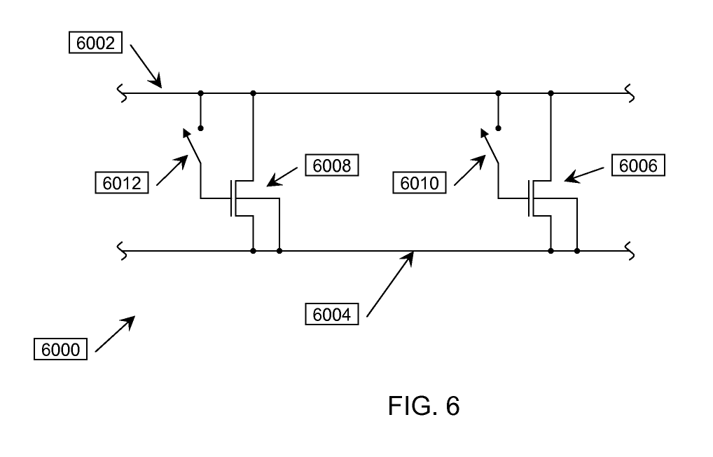

FIG. 6 is a circuit diagram of an integrated circuit containing a self-regulating isolated p-well bias voltage source using an NMOS diode formed according to a sixth embodiment. The integrated circuit (6000) contains a data storage circuit (such as an SRAM, a DRAM or a logic latch) having data storage cells. Each data storage cell includes NMOS transistors (such as element 4004 of FIG. 4A). One or more isolated p-wells underlying each data storage cell and contain those NMOS transistors. The isolated p-wells are connected to an isolated p-well bias node (6002) (that may be an isolated p-well bias bus), as depicted in FIG. 6. The integrated circuit voltage source (6004) may have a lower voltage level than desired for the targeted amount of power consumption in the NMOS transistors. Therefore, a self-regulating isolated p-well bias voltage source is formed by coupling a voltage source (6004) to a first NMOS diode (6006) that is in parallel with a second NMOS diode (6008). The first NMOS diode (6006) and second NMOS diode (6008) are coupled to the isolated p-well bias node (6002). More specifically, a source node of the first NMOS diode (6006) is connected to the voltage source (6004), a drain node of the first NMOS diode (6006) is connected to the isolated p-well bias node (6002), and a gate node of the first NMOS diode (6006) is coupled to the isolated p-well bias node (6002) through a first isolated p-well mode switch (6010). In addition, a source node of the second NMOS diode (6008) is connected to the integrated circuit voltage source (6004), a drain node of the second NMOS diode (6008) is connected to the isolated p-well bias node (6002), and a gate node of the second NMOS diode (6008) is coupled to the isolated p-well bias node (6002) through a second isolated p-well mode switch (6012).

During the operation of the data storage circuit (for example, a first reduced power data retention mode), the first isolated p-well mode switch (6010) may be closed and the second isolated p-well mode switch (6012) may be opened. This may enable the first NMOS diode (6006) to regulate a bias voltage on the isolated p-well bias node (6002) in a first desired voltage range as a function of the current flowing through the first NMOS diode (6006). During another mode of operation (for example, a second reduced power data retention mode), the first isolated p-well mode switch (6010) may be opened and the second isolated p-well mode switch (6012) may be closed. This may enable the second NMOS diode (6008) to regulate a bias voltage on the isolated p-well bias node (6002) in a second desired voltage range as a function of current flowing through the second NMOS diode (6008). During yet another mode of operation (for example, a third reduced power data retention mode), the first isolated p-well mode switch (6010) and the second isolated p-well mode switch (6012) may be closed. This may enable the first NMOS diode (6006) and the second NMOS diode (6008) to regulate a bias voltage on the isolated p-well bias node (6002) in a third desired voltage range as a function of the current flowing through both the first NMOS diode (6006) and the second NMOS diode (6008).

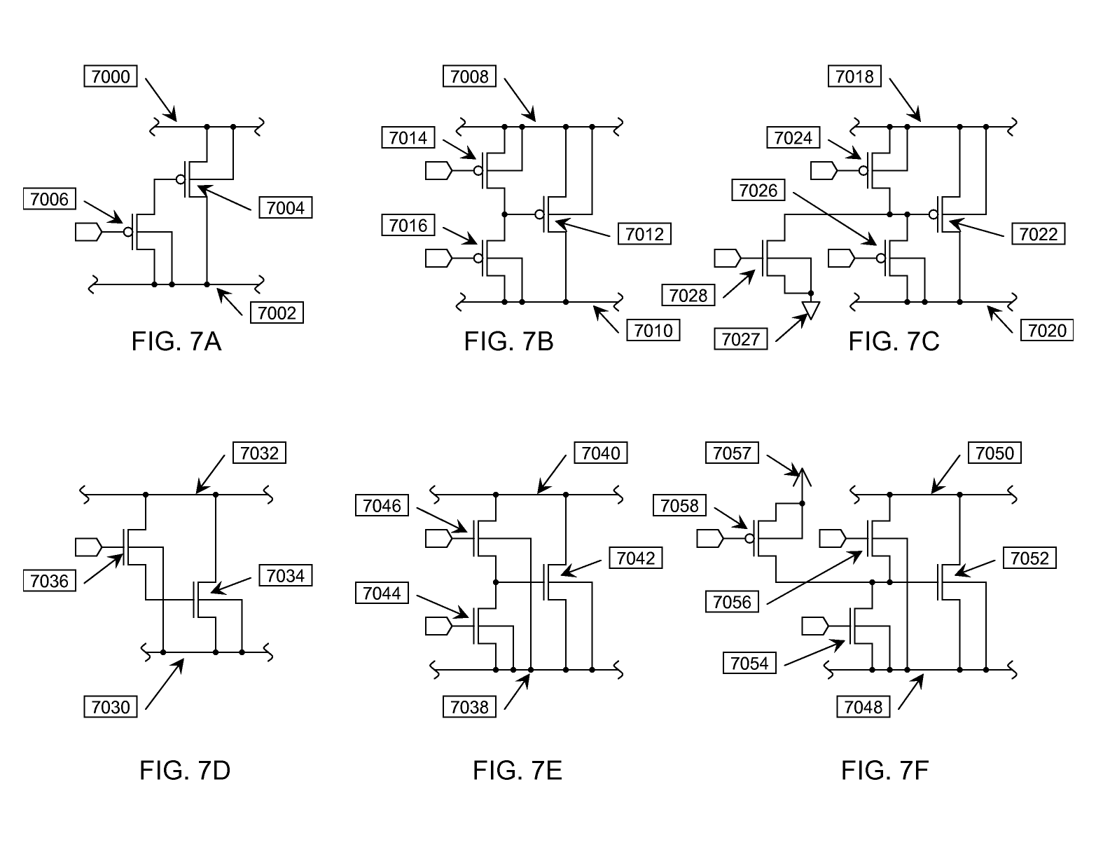

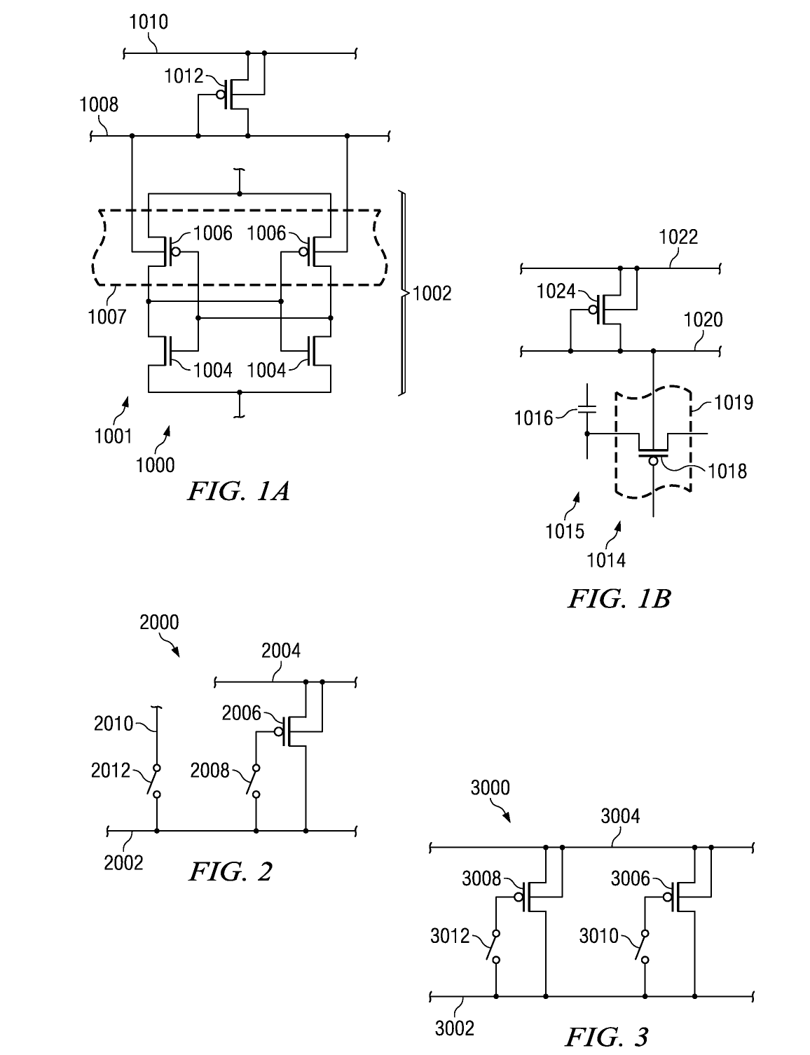

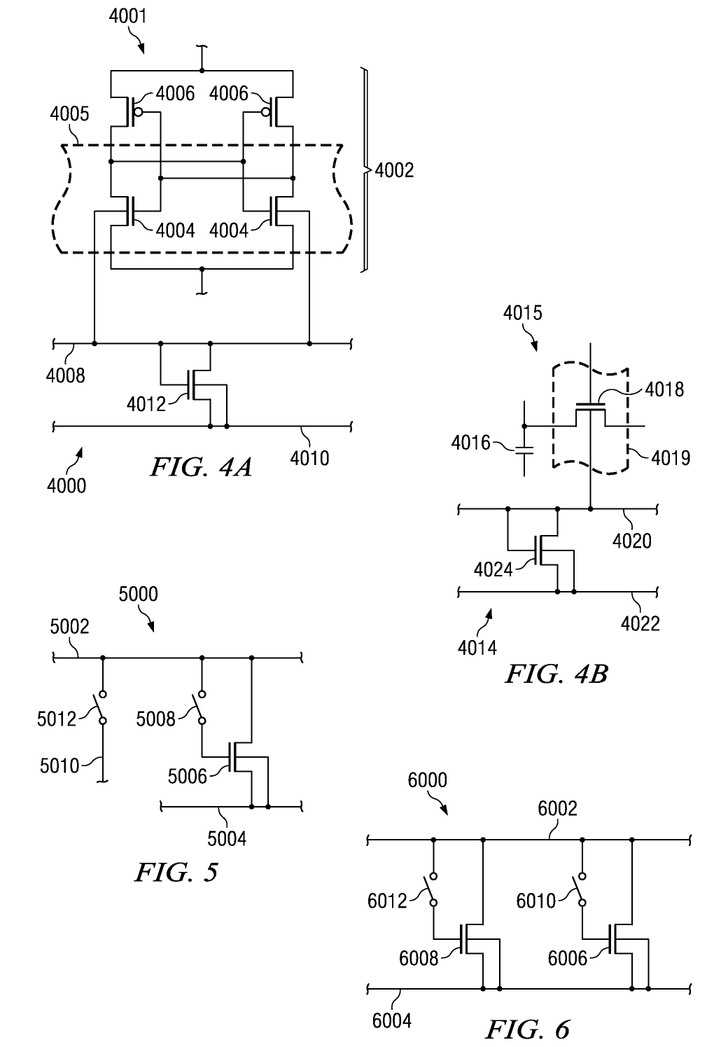

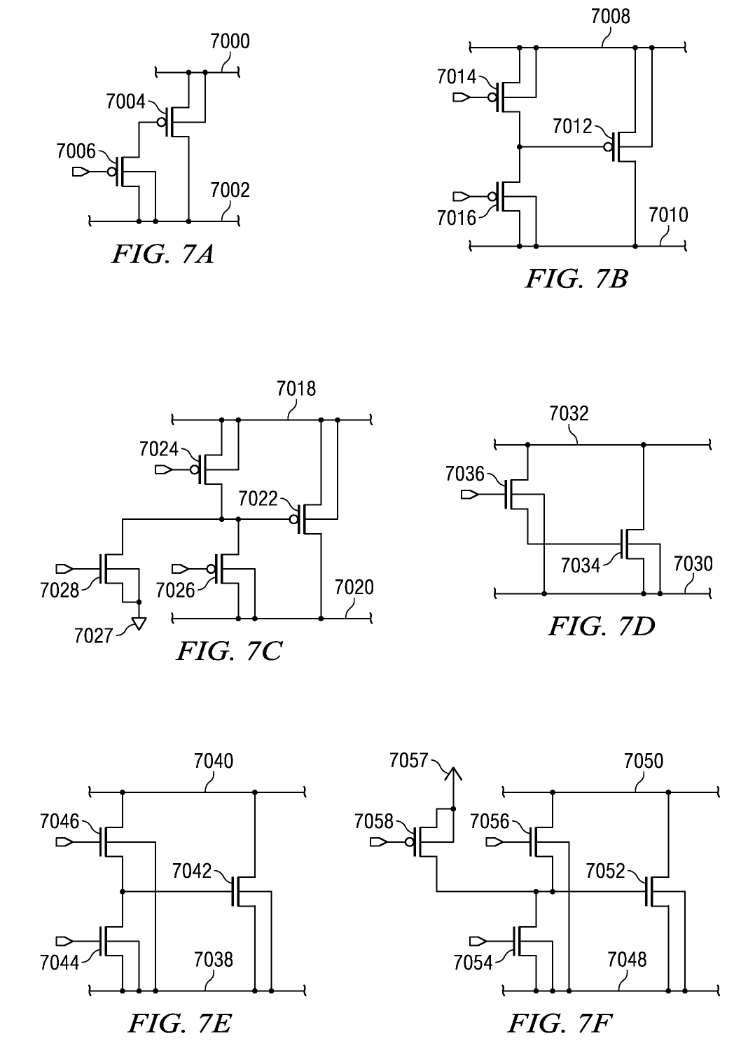

FIG. 7A through FIG. 7F are circuit diagrams of embodiments of switches which may be used to couple gate nodes of PMOS diodes or NMOS diodes to n-well bias nodes or isolated p-well bias nodes, respectively. It is within the scope of the embodiments recited herein to use other switch means to couple gate nodes of PMOS diodes or NMOS diodes to n-well bias nodes or isolated p-well bias nodes, respectively.

Referring to FIG. 7A, an integrated circuit voltage source (7000) is coupled to an n-well bias node (7002) through a PMOS diode (7004) as described in reference to FIG. 2. (The PMOS diode (7004) could be PMOS diode (1012) of FIG. 1A.) A gate node of the PMOS diode (7004) is coupled to the n-well bias node (7002) through a first PMOS bias transistor (7006) which may provide a desired switch function. A first source/drain node of the first PMOS bias transistor (7006) is connected to the gate node of the PMOS diode (7004) and a second source/drain node of the first PMOS bias transistor (7006) is connected to the n-well bias node (7002).

Referring to FIG. 7B, an integrated circuit voltage source (7008) is coupled to an n-well bias node (7010) through a PMOS diode (7012) as described in reference to FIG. 2. (The PMOS diode (7012) could be PMOS diode (1012) of FIG. 1A.) A gate node of the PMOS diode (7012) is coupled to the integrated circuit voltage source (7008) through a second PMOS bias transistor (7014) and is coupled to the n-well bias node (7010) through a first PMOS bias transistor (7016). A first source/drain node of the second PMOS bias transistor (7014) is connected to the gate node of the PMOS diode (7012) and a second source/drain node of the second PMOS bias transistor (7014) is connected to the integrated circuit voltage source (7008). A first source/drain node of the first PMOS bias transistor (7016) is connected to the gate node of the PMOS diode (7012) and a second source/drain node of the first PMOS bias transistor (7016) is connected to the n-well bias node (7010). A desired potential on the gate node of the PMOS diode (7012) is achieved by adjusting the bias potentials on the gate nodes of the second PMOS bias transistor (7014) and the first PMOS bias transistor (7016).

Referring to FIG. 7C, an integrated circuit voltage source (7018) is coupled to an n-well bias node (7020) through a PMOS diode (7022) as described in reference to FIG. 2. (The PMOS diode (7022) could be PMOS diode (1012) of FIG. 1A.) A gate node of the PMOS diode (7022) is coupled to the integrated circuit voltage source (7018) through a first PMOS bias transistor (7026) and it is also coupled to the n-well bias node (7020) through a second PMOS bias transistor (7024). A first source/drain node of the second PMOS bias transistor (7024) is connected to the gate node of the PMOS diode (7022) and a second source/drain node of the second PMOS bias transistor (7024) is connected to the integrated circuit voltage source (7018). A first source/drain node of the first PMOS bias transistor (7026) is connected to the gate node of the PMOS diode (7022) and a second source/drain node of the first PMOS bias transistor (7026) is connected to the n-well bias node (7020). The gate node of the PMOS diode (7022) is also coupled to a ground node (7027) of an integrated circuit containing the PMOS diode (7022) through a NMOS bias transistor (7028).

In a diode mode of operation, a desired potential on the gate node of the PMOS diode (7022) is achieved by adjusting the bias potentials on the gate nodes of the first PMOS bias transistor (7026) and the second PMOS bias transistor (7024) while the NMOS bias transistor is turned off. As a result, a bias voltage on the n-well bias node (7020) may be regulated as a function of the current through the PMOS diode (7022).

In a switch mode of operation, the first PMOS bias transistor (7026) and the second PMOS bias transistor (7024) are turned off and the NMOS bias transistor (7028) is turned on. As a result, the PMOS diode (7022) provides a low impedance path between the integrated circuit voltage source (7018) and the n-well bias node (7020) that is less sensitive to the current through the PMOS diode (7022) than in the diode mode of operation.

Referring to FIG. 7D, an integrated circuit voltage source (7030) is coupled to an isolated p-well bias node (7032) through an NMOS diode (7034) as described in reference to FIG. 5. (The NMOS diode (7034) could be the NMOS diode (4012) of FIG. 4A.) A gate node of the NMOS diode (7034) is coupled to the isolated p-well bias node (7032) through a first NMOS bias transistor (7036) that may provide a switch function. A first source/drain node of the first NMOS bias transistor (7036) is connected to the gate node of the NMOS diode (7034) and a second source/drain node of the first NMOS bias transistor (7036) is connected to the isolated p-well bias node (7032).

Referring to FIG. 7E, an integrated circuit voltage source (7038) is coupled to an isolated p-well bias node (7040) through an NMOS diode (7042) as described in reference to FIG. 5. (The NMOS diode (7042) could be the NMOS diode (4012) of FIG. 4A.) A gate node of the NMOS diode (7042) is coupled to the integrated circuit voltage source (7038) through a second NMOS bias transistor (7044) and is coupled to the isolated p-well bias node (7040) through a first NMOS bias transistor (7046). A first source/drain node of the second NMOS bias transistor (7044) is connected to the gate node of the NMOS diode (7042) and a second source/drain node of the second NMOS bias transistor (7044) is connected to the integrated circuit voltage source (7038). A first source/drain node of the first NMOS bias transistor (7046) is connected to the gate node of the NMOS diode (7042) and a second source/drain node of the first NMOS bias transistor (7046) is connected to the isolated p-well bias node (7040). A desired potential on the gate node of the NMOS diode (7042) is achieved by adjusting the bias potentials on the gate nodes of the first NMOS bias transistor (7046) and the second NMOS bias transistor (7044).

Referring to FIG. 7F, an integrated circuit voltage source (7048) is coupled to an isolated p-well bias node (7050) through an NMOS diode (7052) as described in reference to FIG. 5. (The NMOS diode (7052) could be the NMOS diode (4012) of FIG. 4A.) A gate node of the NMOS diode (7052) is coupled to the integrated circuit voltage source (7048) through a second NMOS bias transistor (7054) and is coupled to the isolated p-well bias node (7050) through a first NMOS bias transistor (7056). A first source/drain node of the second NMOS bias transistor (7054) is connected to the gate node of the NMOS diode (7052) and a second source/drain node of the second NMOS bias transistor (7054) is connected to the integrated circuit voltage source (7048). A first source/drain node of the first NMOS bias transistor (7056) is connected to the gate node of the NMOS diode (7052) and a second source/drain node of the first NMOS bias transistor (7056) is connected to the isolated p-well bias node (7050). The gate node of the NMOS diode (7052) is also coupled to a power supply node (7057) of the integrated circuit through a PMOS bias transistor (7058).

In a diode mode of operation, a desired potential on the gate node of the NMOS diode (7052) is achieved by adjusting the bias potentials on the gate nodes of both the first NMOS bias transistor (7056) and the second NMOS bias transistor (7054) while the PMOS transistor is turned off. As a result, a bias voltage on the isolated p-well bias node (7050) may be regulated as a function of the current through the NMOS diode (7052).

In a switch mode of operation, the first NMOS bias transistor (7056) and the second NMOS bias transistor (7054) are turned off while the PMOS bias transistor (7058) is turned on. As a result, the NMOS diode (7052) may provide a low impedance path between the integrated circuit voltage source (7048) and the isolated p-well bias node (7050) that is less sensitive to the current through the NMOS diode (7052) than in the diode mode of operation.

While various embodiments have been described above, it should be understood that they have been presented by way of example only and not limitation. Numerous changes to the disclosed embodiments can be made in accordance with the disclosure herein without departing from the spirit or scope of those embodiments. Thus, the breadth and scope of the embodiments should be defined in accordance with the following claims and their equivalents.

What is claimed is:

1. An integrated circuit, comprising:
a data storage cell located within said integrated circuit, said data storage cell having a PMOS transistor;
an n-well underlying said data storage cell, wherein said PMOS transistor is located within said n-well;
an n-well bias node connected to said n-well;
a PMOS diode, said PMOS diode including a source node, a drain node and a gate node, wherein said drain node of said PMOS diode is connected to said n-well bias node and said gate node of said PMOS diode is also coupled to said n-well bias node; and
an integrated circuit voltage source connected to said source node of said PMOS diode.

2. The integrated circuit of claim 1, further including a first n-well mode switch, such that said gate node of said PMOS diode is coupled to said n-well bias node through said first n-well mode switch.

3. The integrated circuit of claim 2, further including:
an alternate n-well bias source; and
a second n-well mode switch, such that said second n-well mode switch couples said alternate n-well bias source to said n-well bias node.

4. The integrated circuit of claim 2, further including a first PMOS bias transistor, said first PMOS bias transistor including a first source/drain node and a second source/drain node, such that said first source/drain node of said first PMOS bias transistor is connected to said gate node of said PMOS diode and said second source/drain node of said first PMOS bias transistor is connected to said n-well bias node.

5. The integrated circuit of claim 4, further including:
an NMOS bias transistor, said NMOS transistor including a first source/drain node and a second source/drain node, such that said first source/drain node of said NMOS bias transistor is connected to said gate node of said PMOS diode and said second source/drain node of said NMOS bias transistor is connected to a ground node of said integrated circuit; and
a second PMOS bias transistor, said second PMOS bias transistor including a first source/drain node and a second source/drain node, such that said first source/drain node of said second PMOS bias transistor is connected to the gate node of the PMOS diode and said second source/drain node of the second PMOS bias transistor is connected to the integrated circuit voltage source.

6. The integrated circuit of claim 2, further including a second PMOS diode, said second PMOS diode including a source node, a drain node and a gate node, such that said source node of said second PMOS diode is connected to said integrated circuit voltage source, said drain node of said second PMOS diode is connected to said n-well bias node, and said gate node of said second PMOS diode is connected to said n-well bias node through a second n-well mode switch.

7. An integrated circuit, comprising:
a data storage cell located within said integrated circuit, said data storage cell having an NMOS transistor;
an isolated p-well underlying said data storage cell, wherein said NMOS transistor is located within said isolated p-well;
an isolated p-well bias node connected to said isolated p-well;
an NMOS diode, said NMOS diode including a source node, a drain node and a gate node, wherein said drain node of said NMOS diode is connected to said isolated p-well bias node and said gate node of said NMOS diode is coupled to said isolated p-well bias node; and
an integrated circuit voltage source connected to said source node said NMOS diode.

8. The integrated circuit of claim 7, further including a first isolated p-well mode switch, such that said gate node of said NMOS diode is coupled to said isolated p-well bias node through said first isolated p-well mode switch.

9. The integrated circuit of claim 8, further including:
an alternate isolated p-well bias source; and
a second isolated p-well mode switch, such that said second isolated p-well mode switch couples said alternate isolated p-well bias source to said isolated p-well bias node.

10. The integrated circuit of claim 7, further including a first NMOS bias transistor, said first NMOS bias transistor including a first source/drain node and a second source/drain node, such that said first source/source node of said first NMOS bias transistor is connected to said isolated p-well bias node and said second source/drain node of said first NMOS bias transistor is connected to said gate node of said NMOS diode.

11. The integrated circuit of claim 10, further including:
a PMOS bias transistor, said PMOS bias transistor including a first source/drain node and a second source/drain node, such that said first source/drain node of said PMOS bias transistor is connected to said gate node of said NMOS diode and said second source/drain node of said PMOS bias transistor is connected to a power supply node of said integrated circuit; and
a second NMOS bias transistor, said second NMOS bias transistor including a first source/drain node and a second source/drain node, such that said first source/drain node of said second NMOS bias transistor is connected to the gate node of the NMOS diode and said second source/drain node of the second NMOS bias transistor is connected to the integrated circuit voltage source.

12. The integrated circuit of claim 8, further including a second NMOS diode, said second NMOS diode including a source node, a drain node and a gate node, such that said source node of said second NMOS diode is connected to said integrated circuit voltage source, said drain node of said second NMOS diode is connected to said isolated p-well bias node and said gate node of said second NMOS diode is coupled to said isolated p-well bias node through a second isolated p-well mode switch.
